(19) United States
(12) Patent Application Publication
(10) Pub. No.: US 2018/0231192 A1
(43) Pub. Date: Aug. 16, 2018

(54) MULTI-FUNCTIONAL DETACHABLE LIGHTING APPARATUS AND SYSTEMS

(71) Applicant: Aixia Bian, Shanghai (CN)

(72) Inventor: Aixia Bian, Shanghai (CN)

(21) Appl. No.: 15/640,706

(22) Filed: Jul. 3, 2017

Related U.S. Application Data
(60) Provisional application No. 62/457,315, filed on Feb. 10, 2017.

(51) Int. Cl. F21L 4/00; F21V 23/06; F21V 23/04; F21V 9/16; F21V 7/22; F21V 31/00; F21V 21/08; F21V 19/00; F21V 7/06

(52) U.S. Cl. CPC F21L 4/00; F21V 23/06; F21V 23/0414; F21V 9/16; F21Y 2115/10; F21V 31/00; F21V 21/08; F21V 19/003; F21V 7/06; F21V 7/22

(57) ABSTRACT

A portable lighting apparatus includes an elongated housing having a radially-central cavity extending longitudinally along the elongated housing; one or more rods operable to extend coaxially from the radially-central cavity; one or more hooks coupled to distal ends of the respective one or more rods; one or more clips secured to the elongated housing; and a detachable lighting apparatus removably secured to the one or more clips, the detachable lighting apparatus being substantially cylindrical in shape, wherein the detachable lighting apparatus includes one or more light emitting diodes (LEDs) affixed to a surface of the detachable lighting apparatus and operable to emit light.

### CROSS REFERENCE TO RELATED APPLICATION

This application is a non-provisional application claiming priority from U.S. Provisional Application Ser. No. 62/457,315, filed on Feb. 10, 2017, entitled “MULTI-FUNCTIONAL DETACHABLE LIGHTING APPARATUS” and incorporated herein by reference in its entirety.

### BACKGROUND OF THE INVENTION

Advances in technology have enabled lighting devices to become increasingly lightweight and portable. Light emitting diodes (LEDs) are capable of efficiently converting electrical energy into light with little waste heat, allowing them to provide extended illumination with portable energy sources, such as batteries.

Environmental or ambient lighting may provide insufficient illumination, in some conditions or circumstances. For example, typical ceiling lamps or standing work lights may not adequately illuminate the engine bay of an automobile. It is accordingly an objective of the present invention to provide lighting apparatuses configured for or adapted to illuminate otherwise dimly lit regions.

Lighting apparatuses that illuminate otherwise dimly lit regions may be portable and rely upon stored energy in a capacitor or battery in order to power light sources thereon. Single-use disposable batteries may be convenient in some applications, but requires the user to maintain a supply of backup batteries to replace the drained single-use batteries. Additionally, swapping out dead batteries for new batteries requires a lighting device to be shut off, which can be inconvenient. It is accordingly another objective of the present invention to provide lighting apparatuses configured with rechargeable energy storage devices.

### SUMMARY OF THE INVENTION

An aspect of the present application describes a portable lighting apparatus. The portable lighting apparatus includes an elongated housing having a radially-central cavity extending longitudinally along the elongated housing. The portable lighting apparatus also includes one or more rods operable to extend coaxially from the radially-central cavity. The portable lighting apparatus further includes one or more hooks coupled to distal ends of the respective one or more rods. Additionally, the portable lighting apparatus includes one or more clips secured to the elongated housing. Further, the portable lighting apparatus includes a detachable lighting apparatus removably secured to the one or more clips that is substantially cylindrical in shape. The detachable lighting apparatus includes one or more light emitting diodes (LEDs) affixed to a surface of the detachable lighting apparatus and operable to emit light. Further, the detachable lighting apparatus may include a battery operable to power the one or more LEDs.

In some embodiments, the detachable lighting apparatus further includes a substantially cylindrical separable battery operable to supply power to the LEDs of the detachable lighting apparatus. In some of such embodiments, the detachable lighting apparatus has a first diameter, the substantially cylindrical separable battery has a second diameter, and the first diameter is approximately equal to the second diameter. In some other of such embodiments, the detachable lighting apparatus has a first diameter, the momentary magnetic switch has a second diameter, and the first diameter is approximately equal to the second diameter. In yet still some of such embodiments of the detachable lighting apparatus, the substantially cylindrical battery is disposed within a battery housing, the one or more LEDs are affixed to a surface of a main housing of the detachable lighting apparatus, and the battery housing is removably coupled to the main housing. For example, the battery housing may include one or more first electrical contacts, wherein the main housing includes one or more second electrical contacts, and wherein the one or more first electrical contacts electrically couple with the one or more second electrical contacts to provide power to the one or more LEDs.

In some other embodiments, the detachable lighting apparatus further includes a substantially cylindrical momentary magnetic switch configured to selectively energize the one or more LEDs of the detachable lighting apparatus.

In still some other embodiments, the detachable lighting apparatus includes a transparent cover at least partially surrounding the one or more LEDs.

In still some other embodiments of the portable lighting apparatus, the surface of the detachable lighting apparatus on which the one or more LEDs is affixed includes: a photoluminescent coating covering at least a portion of the surface of the detachable lighting apparatus, wherein the photoluminscent coating is adapted to emit light for a duration of time after being irradiated by a light source. Alternatively, the surface of the detachable lighting apparatus on which the one or more LEDs is affixed may include a reflective coating covering at least a portion of the surface of the detachable lighting apparatus, wherein the reflective coating is adapted to distribute light emitted by the one or more LEDs.

In still some other embodiments of the portable lighting apparatus, at least the one or more LEDs of the detachable lighting apparatus are sealedly contained within a water-resistant housing.

In still some other embodiments of the portable lighting apparatus, each of the one or more hooks is substantially triangular in shape; each of the one or more hooks is rotatably coupled to the respective one or more rods; or each of the one or more hooks is detachably coupled to the respective one or more rods.

In still some other embodiments of the portable lighting apparatus, the one or more LEDs are surface mount device (SMD) LEDs, or the one or more LEDs are chips on board (COB) LEDs.

In still some other embodiments of the portable lighting apparatus, the detachable lighting apparatus is at least partially formed from metal and adapted to dissipate heat produced by the one or more LEDs.

Another aspect of the present application describes a detachable lighting apparatus adapted to be removably coupleable with one or more clips secured to an elongated housing. The detachable lighting apparatus is substantially cylindrical in shape, and it includes one or more light emitting diodes (LEDs) affixed to a surface of the detachable lighting apparatus and operable to emit light, a substantially cylindrical separable battery operable to supply power to the LEDs of the detachable lighting apparatus, and a substantially cylindrical momentary magnetic switch configured to selectively energize the one or more LEDs with power supplied from the battery.

Yet another aspect of the present application describes a portable lighting system that includes a substantially cylindrical battery pack, a substantially cylindrical portable lighting rod, and a multi-functional base. The battery pack includes a battery and a battery connector that provides an electrical connection to the battery. The portable lighting rod includes one or more light emitting diodes (LEDs) affixed to a surface of the portable lighting rod and operable to emit light. The portable lighting rod also includes a power terminal configured to be electrically coupleable with the battery connector, a substantially cylindrical momentary magnetic switch configured to selectively energize the one or more LEDs with power supplied from the battery. The multi-functional base includes a power terminal configured to be electrically coupleable with the battery connector, a charging port configured to be electrically coupleable with a power supply which port serves to charge the battery with power provided from the power supply. The multi-functional base further includes a light emitting region operable to emit light, which region is selectively energized with power provided by the battery.

In some embodiments of the portable lighting system, the light emitting region Includes a light reflector having a substantially paraboloid shape, one or more base LEDs disposed within the light reflector and operable to emit light; and an annular light emitting substrate arranged to surround the light reflector, wherein the annular light emitting substrate is operable to emit light. In these embodiments, the annular light emitting substrate may be a chip-on-board (COB) LED.

In some embodiments of the portable lighting system, the multi-functional base further includes a power switch configured to selectively energize the light emitting region with power provided by the battery.

The foregoing summary is illustrative only and is not intended to be in any way limiting. In addition to the illustrative aspects, embodiments, and features described above, further aspects embodiments, and features will become apparent by reference to the figures and the following detailed description and the accompanying drawings

### BRIEF DESCRIPTIONS OF THE DRAWINGS

FIG. 1A is a perspective view of a detachable multi-functional lighting apparatus, according to an example embodiment.

FIG. 1B is a perspective view of a detachable multi-functional lighting apparatus, according to an example embodiment.

FIG. 1C is a front view of a detachable multi-functional lighting apparatus, according to an example embodiment.

FIG. 1D is a back view of a detachable multi-functional lighting apparatus, according to an example embodiment.

FIG. 1E is a bottom-up view of a detachable multi-functional lighting apparatus, according to an example embodiment.

FIG. 1F is a top-down view of a detachable multi-functional lighting apparatus, according to an example embodiment.

FIG. 1G is a side view of a detachable multi-functional lighting apparatus, according to an example embodiment.

FIG. 1H is a side view of a detachable multi-functional lighting apparatus, according to an example embodiment.

FIG. 1I is a perspective view illustrating the detachable lighting apparatus separated from the housing, according to an example embodiment.

FIG. 2A is a perspective view of the detachable lighting apparatus, according to an example embodiment.

FIG. 2B is a perspective view of the detachable lighting apparatus illustrating a removable battery separated from the main body of the detachable lighting apparatus, according to an example embodiment.

FIG. 3A is a perspective view of a multi-functional base separated and in coaxial alignment with the removable battery, according to an example embodiment.

FIG. 3B is a perspective view of the multi-functional base electrically connected to the removable battery, according to an example embodiment.

FIG. 3C is a perspective view showing a light emitting region of the multi-functional base, according to an example embodiment.

FIG. 3D is an elevated side view of the multi-functional base electrically connected to the removable battery, according to an example embodiment.

### DETAILED DESCRIPTION OF THE INVENTION

The following description of example methods and apparatus is not intended to limit the scope of the description to the precise form or forms detailed herein. Instead the following description is intended to be illustrative so that others may follow its teachings.

The present application discloses multi-functional lighting apparatuses. An example lighting apparatus includes an elongated housing with one or more central cavities at the distal and proximal ends of the housing. The elongated housing includes one or more clips for securing a substantially cylindrical detachable lighting rod. A surface of the detachable lighting rod has mounted thereon one or more LEDs, which are operable to project light outward from the surface. The lighting apparatus also includes rods capable of extending coaxially from the ends of the housing. Extending or retracting the rods allows the overall length of the multi-functional lighting apparatus to be adjusted. Hooks are coupled to the distal ends of the rods, allowing the lighting apparatus to be mounted or hung.

A portion of the surface of the detachable lighting rod on which the one or more LEDs are mounted may be coated with a photoluminescent (e.g., fluorescent or phosphorescent) substance that absorbs light—either from the environment and/or from the one or more LEDs—that glows for a duration of time after being removed from the bright environment and/or after the LEDs have been turned off. The light emitted from the photoluminescent substance, although dimmer than the LED light, allows the lighting apparatus to be located in dark environments.

The example multi-functional lighting apparatus may be powered via replaceable or rechargeable batteries. In some instances, the multi-functional lighting apparatus includes a charging port into which a connector of a power source can be inserted to supply power to rechargeable batteries of the multi-functional lighting apparatus. In other instances, the multi-functional lighting apparatus includes a receptacle with conductive contacts into which one or more batteries may be inserted for powering the multi-functional lighting apparatus.

The detachable lighting rod may be removably secured to the housing via one or more clips. The clips may be permanently secured to the housing, and may form a “U” shape or semicircle that allows the detachable lighting rod to be friction fit within the clips. Due to the detachable nature of the lighting rod, the detachable lighting rod can be rotated about within the clips so as to reorient the surface on which the LEDs are mounted, allowing the light emission to be reoriented without having to adjust the other components of the multi-functional lighting apparatus.

In an example scenario, a mechanic is servicing an automobile engine in a dark or inadequately lit environment. Due to the poor lighting conditions, it is difficult for the mechanic to see the components in the engine bay. The mechanic then locates the multi-functional lighting apparatus from the glow of its photoluminescent surface. Using the example multi-functional lighting apparatus, the mechanic adjusts the length of the rods and orients the hooks so that the lighting apparatus can be hung from the underside of the elevated car hood. By rotating the detachable lighting rod to aim the LEDs mounted thereon downward, the mechanic can illuminate the engine bay, without having to hold a flashlight in one hand while working. The detachable lighting rod can also be removed from the clips and used as a handheld light source as needed.

The rechargeable battery used to power the detachable lighting rod may be disconnected from the detachable lighting rod and electrically connected to other devices. In some embodiments, the removable battery may be connected to a multi-functional base. This multi-functional base may include thereon a charging port capable of receiving electrical power to charge the removable battery. The multi-functional base may also include thereon one or more light emitting regions that can be selectively energized via a switch or button, allowing the base to also serve as a portable flashlight. In this manner, the multi-functional base may serve as a charging station for removable batteries used with the detachable lighting rod. In certain situations, the base may be disconnected from a power source and be used as a flashlight.

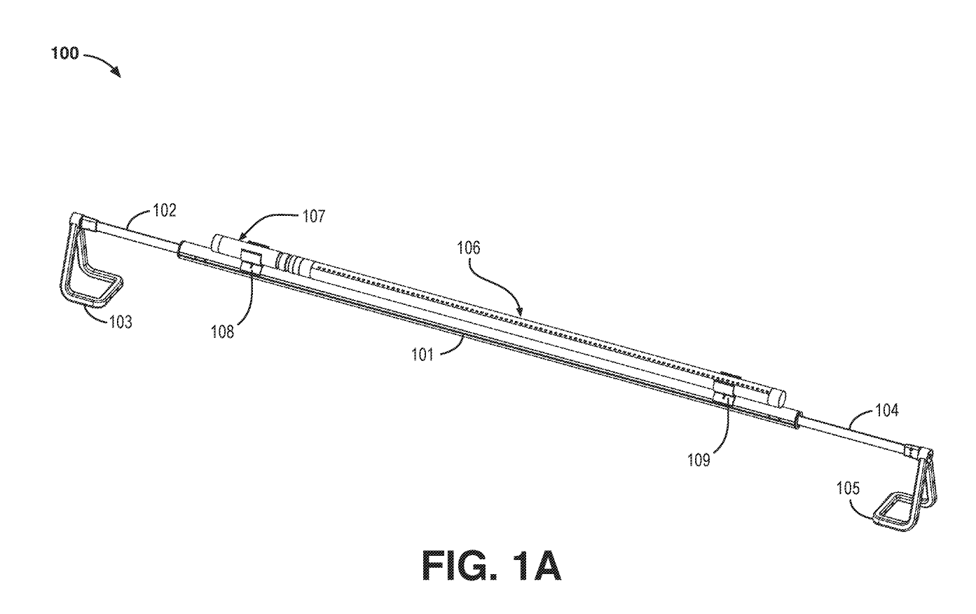

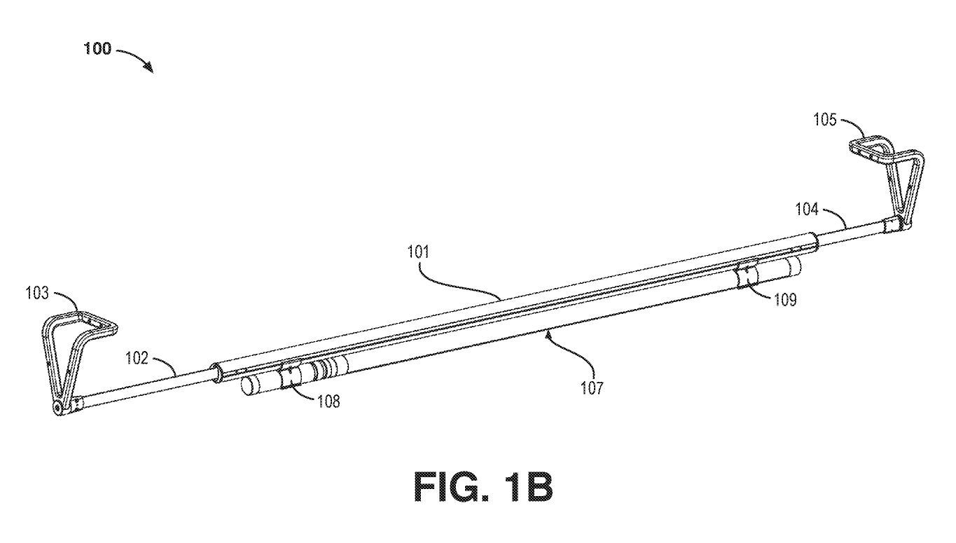

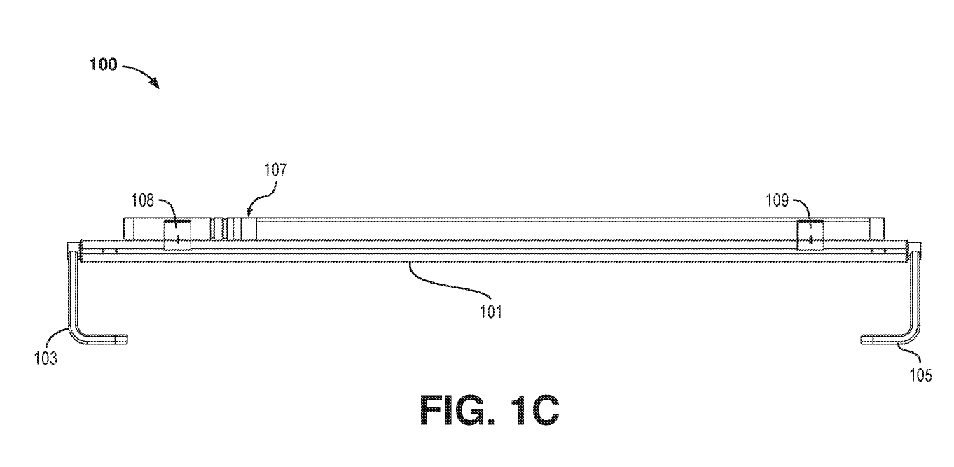

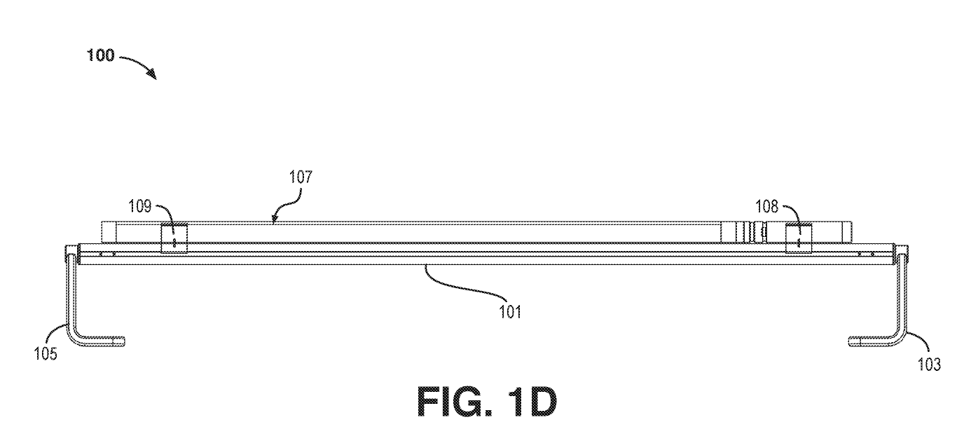

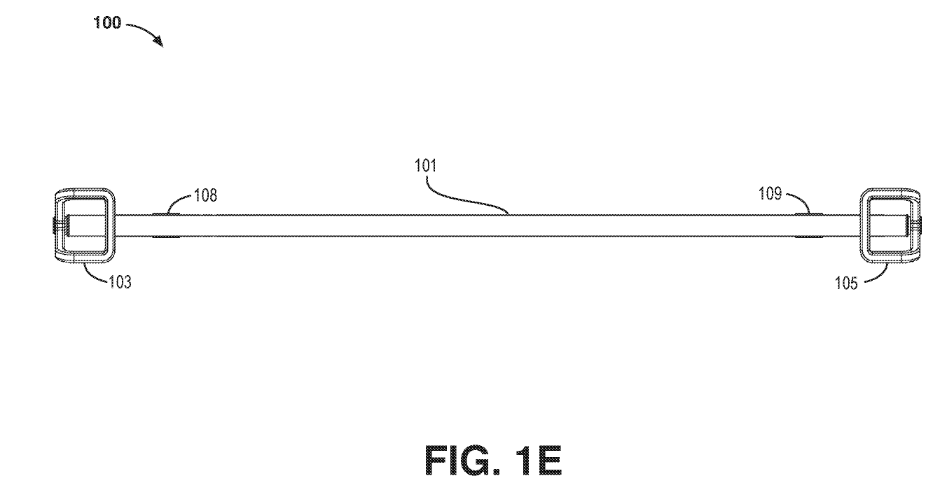

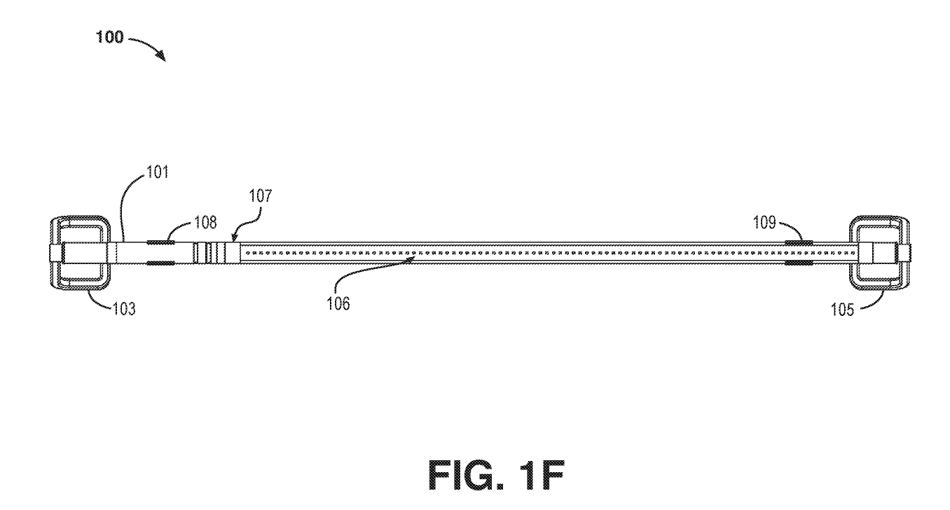

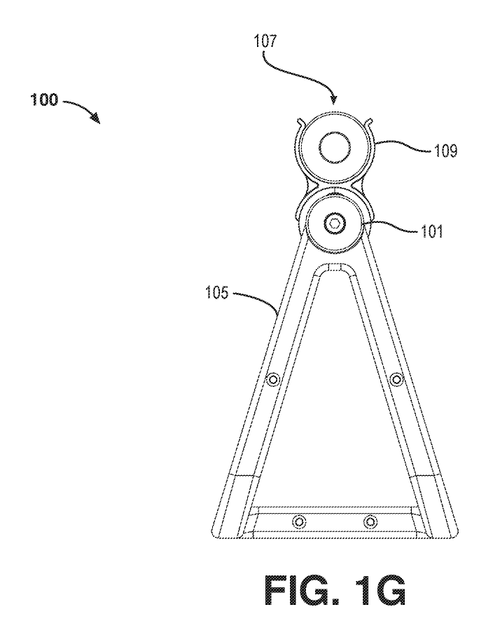

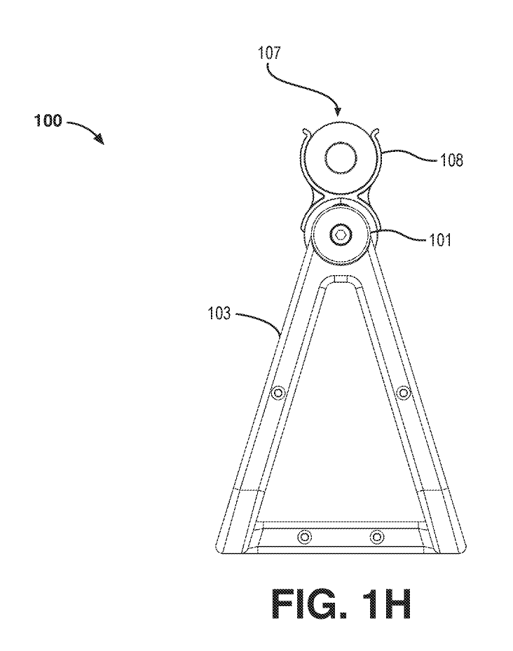

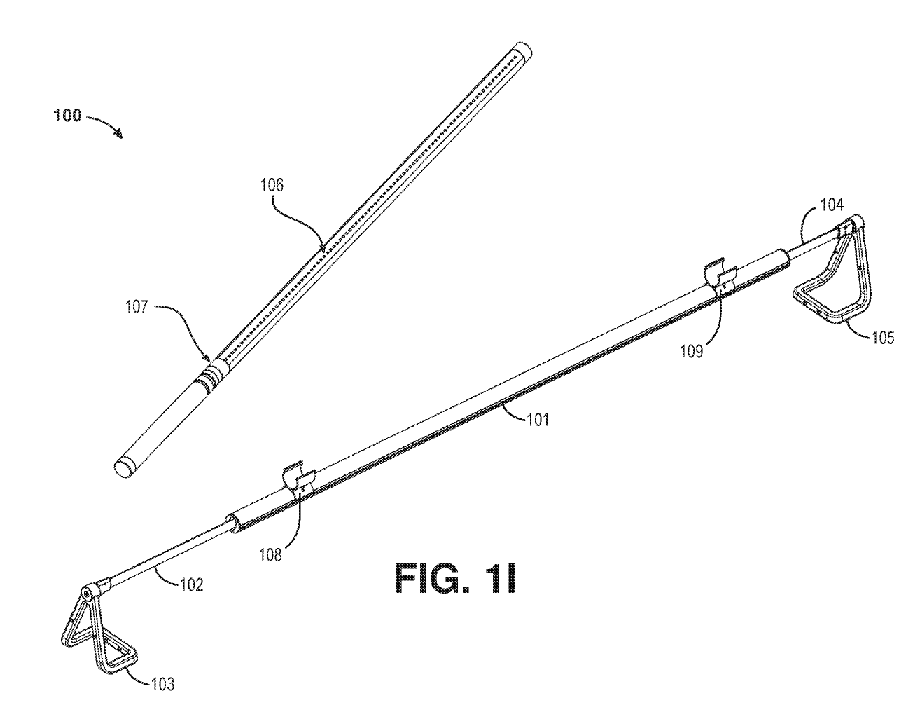

FIGS. 1A-1I illustrate various perspective views of an example multi-functional lighting apparatus. Although the following description relates to this specific example, the present application encompasses other lighting apparatus configurations. The specific arrangement of elements may vary among different embodiments without departing from the scope of the present disclosure.

Referring now to FIG. 1A, a multi-functional lighting apparatus 100 includes an elongated housing 101 with rods 102 and 104 extending coaxially from the ends of the elongated housing 101. The elongated housing 101 includes clips 108 and 109 into which the detachable lighting apparatus 107 is removably secured. A surface of the detachable lighting apparatus 107 includes an illuminated region with LEDs 106 and photoluminscent material surrounding LEDs 106.

The elongated housing 101 may be constructed from a variety of materials, including plastics and metals. In some examples, the elongated housing 101 is constructed from aluminum to be lightweight and to provide durability against impacts or other physical stresses. The elongated housing 101 may, in some embodiments, be circumferentially rotatable with respect to the rods 102 and 104 to allow the elongated housing 101 to be reoriented with respect to the rods 102 and 104.

Rods 102 and 104 may be any kind of elongated member that fits within respective cavities of the elongated housing 101. In some examples, the rods 102 and 104 may friction fit within the housing, such that the rods 102 and 104 are resistant to coaxial movement. The rods 102 and 104 may also be coupled to additional mechanisms, such as a spring or other retention feature, which resists coaxial motion in the distal direction (and also causes the rods to exert a coaxial proximal force, allowing the hooks to grip onto objects). The rods 102 and 104 may be constructed from plastics or metals, among other materials. Additionally, the shape of rods 102 and 104 may be substantially cylindrical, such that the elongated housing 101 can rotate 360° circumferentially.

Rods 102 and 104 may include features or elements that engage with respective features or elements within the central cavity of the elongated housing 101. For example, rods 102 and 104 may include protrusions near the proximal end of rods 102 and 104 which are interference or friction fit with slots or depressions within the elongated housing 101, thereby enabling rods 102 and 104 to be movable under some amount of force, but otherwise stationary to maintain a particular length.

Rods 102 and 104 may be independently movable, such that rod 102 may be extended by a first amount, while rod 104 is extended by a different amount. Such independent movability may permit the multifunctional lighting apparatus 100 to be hooked or attached to an object, while selectively placing the light more to one side than the other. For example, if multifunctional lighting apparatus 100 is hooked on the underside of the hood of an automobile, one of rods 102 and 104 may be extended more than the other to place the LEDs 106 over a specific portion of the engine bay, rather than being centered over the engine bay.

Hooks 103 and 105 are coupled to rods 102 and 104, respectively. In some embodiments, hooks 103 and 105 are curved or angled features at the distal ends of rods 102 and 104. In other embodiments, hooks 103 and 105 are separate elements coupled to the distal ends of rods 102 and 104. The hooks 103 and 105 may be removably coupled to the rods 102 and 104, allowing the hooks 103 and 105 to be removed and replaced with other hooks. In some embodiments, the hooks 103 and 105 may be rotatably coupled to the distal ends of rods 102 and 104, such that the elongated housing 101 and LEDs 106 mounted thereon can be oriented without rotating rods 102 and 104; such rotatably coupled hooks 103 and 105 allow for implementations with rods 102 and 104 having non-symmetrical shapes.

As shown in the figures, hooks 103 and 105 may be triangularly shaped and bent at across two edges of the triangle. However, other hook shapes are possible without departing from the scope of the present disclosure.

As shown in the figures, hooks 103 and 105 may include a combination of materials therein, such as metals, plastics, silicone, and rubber, among other materials. Hooks 103 and 105 may be formed from a rigid material that is covered or surrounded by silicone or rubber to enhance the grip of hooks 103 and 105. Regardless of the particular implementation, hooks 103 and 105 may be formed from a material or coated with a substance to increase the friction between hooks 103 and 105 with surfaces with which hooks 103 and 105 engage.

The detachable lighting apparatus 107 may be substantially cylindrical in shape, and include LEDs 106 mounted on one of its surfaces. The surface on which the LEDs 106 are mounted may also be coated with a photoluminscent substance 110, which may provide a faint glow even when LEDs 106 are turned off. The detachable lighting apparatus 107 may include proximal and distal regions without LEDs. These regions may be used to store batteries, circuitry for driving the LEDs, and control circuitry for turning the LEDs on and off. These regions may also serve as handles or grips when the detachable lighting apparatus 107 is used separately from the multi-functional lighting apparatus 100. The detachable lighting apparatus 107 may also include thereon switches, buttons, or other control interface for operating the detachable lighting apparatus 107 (e.g., turning the LEDs on and off, adjusting LED brightness, switching the operation mode of the LEDs, etc.).

LEDs 106 may be surface mounted device (SMD) LEDs arranged substantially linearly along a surface of the detachable lighting apparatus 107. The LEDs 106 may be of any type, shape, color, or size, depending on the particular implementation. The multi-functional lighting apparatus 100 may also include additional circuit elements for limiting the current supplied to the LEDs, circuitry for driving the LEDs, components for dissipating heat from the LEDs, circuit elements for charging batteries or capacitors that power the LEDs, and/or any other electronic or circuit components to facilitate the powering and/or charging of the multi-functional lighting apparatus 100.

LEDs 106 may include any combination of LED types and/or colors. In some instances, it may be desirable to have a particular LED color (or combination of colors) to accomplish a certain illumination goal. For example, it may be preferable to use white LEDs (i.e., light emitting diodes with a phosphor coating that is excited by monochromatic light to produce a spectrum of wavelengths) to achieve a broad spectrum of absorption. As another example, it may be desirable to use ultra-violet (UV) LEDs, to excite fluorescent dyes or otherwise illuminate UV-reactive substances. One of ordinary skill would appreciate the benefits of using different LED colors in various applications.

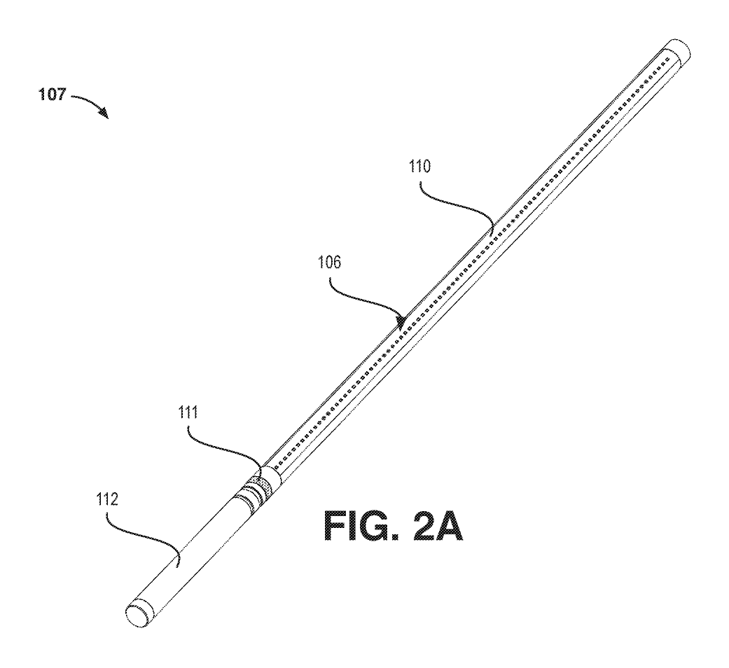

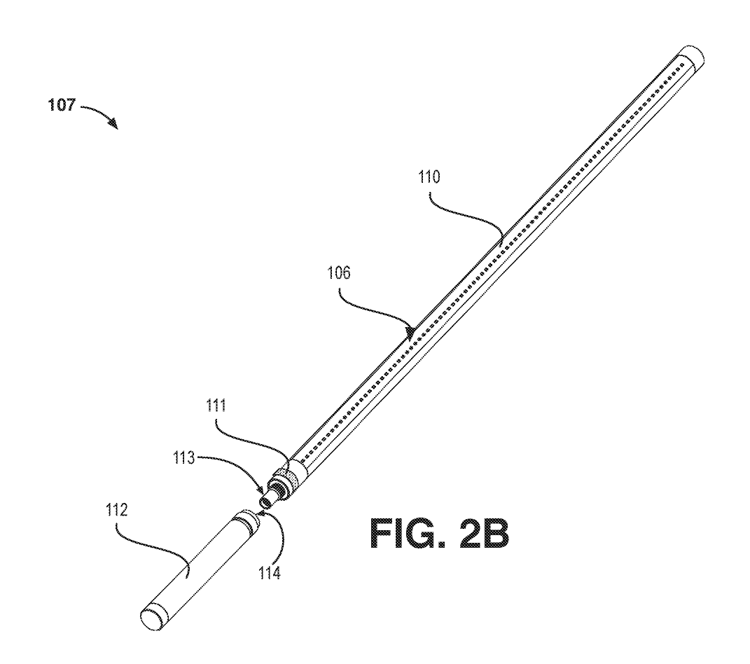

As shown in FIG. 2A, the detachable lighting apparatus 107 includes LEDs 106 surrounded by photoluminescent region 110. In some examples, the LEDs and photoluminescent region 110 may be covered by a transparent or translucent cover, such as glass or plastic, to protect the LEDs 106 and photoluminescent region 110. The detachable lighting apparatus 107 also includes a magnetic rotary switch 111 for turning the LEDs 106 on and off. The magnetic rotary switch 111 may be cylindrical in shape and, in some implementations, is approximately the same diameter as that of the detachable lighting apparatus 107.

The detachable lighting apparatus 107 also includes a separable battery pack 112. The battery pack 112 may be substantially cylindrical in shape and has approximately the same diameter as the detachable lighting apparatus 107, such that the combination of detachable lighting apparatus 107, magnetic rotary switch 111, and battery pack 112 appear as a single rod.

As shown in FIG. 2B, the battery pack 112 may be separable from the rotary switch 111 and detachable lighting apparatus 107, such that it can be swapped out with other battery packs or be removed for charging or disposal. The detachable lighting apparatus 107 may include a rod-side connector 113, while the battery pack 112 includes a battery-side connector 114. Connector 113 and connector 114 may be configured to interlock or otherwise couple or engage to form an electrical connection, permitting the detachable lighting apparatus 107 to draw electrical power from battery pack 112 to power the LEDS 106. Connector 113 and connector 114 may be shaped to preferable protect electrical terminals or pins from the environment (e.g., a mortise and tenon-style connection as shown in FIG. 2B). In this example, rod-side connector 113 is a “male” connector, while battery-side connector 114 is a “female” connector.

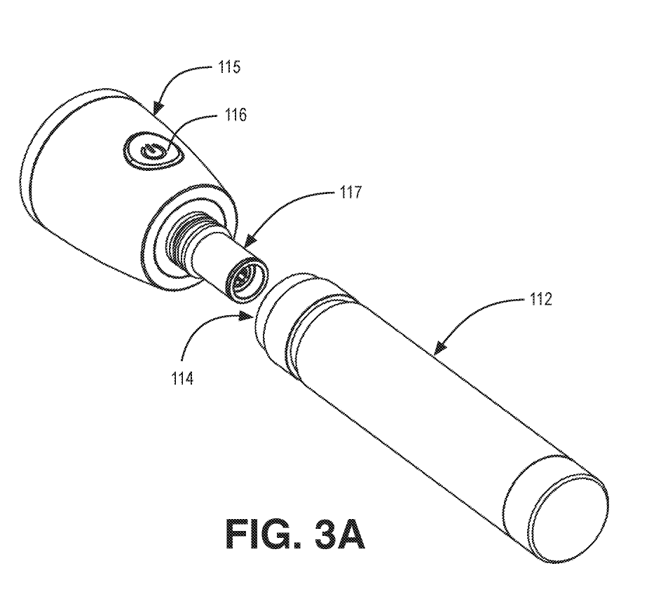

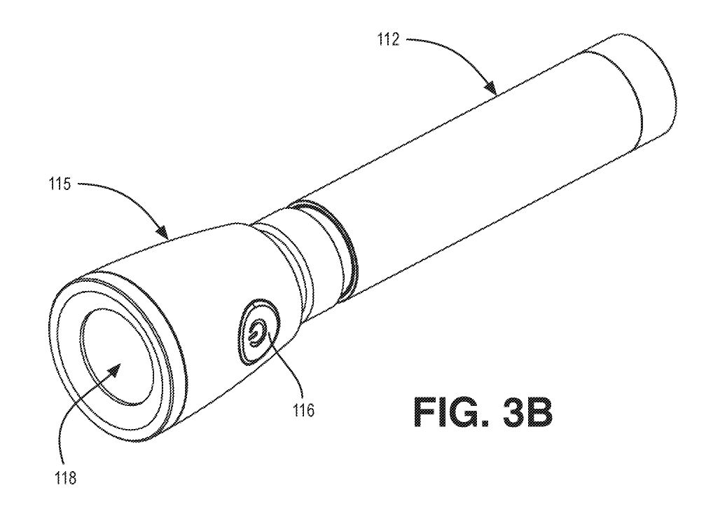

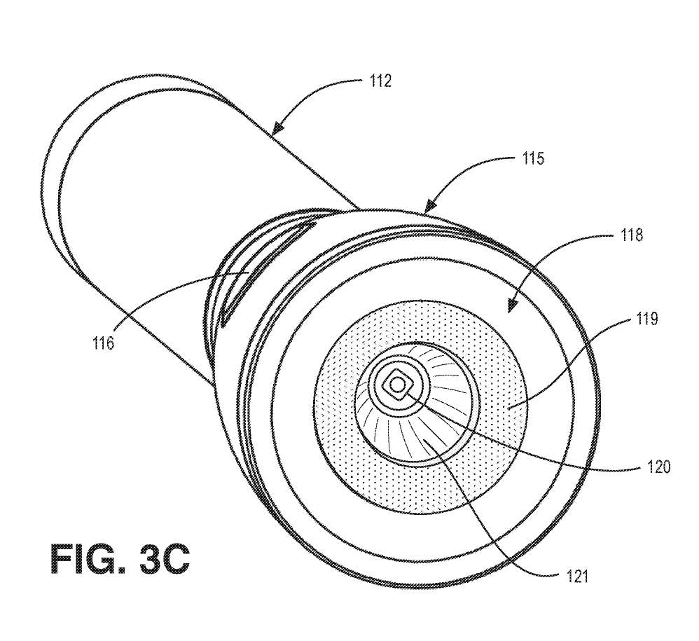

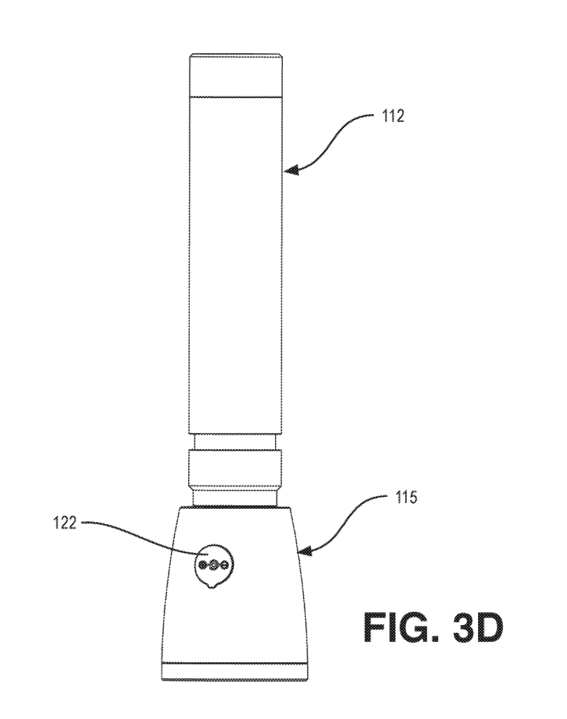

In some embodiments, the battery pack 112 may be configured to electrically connect to devices other than the detachable lighting rod 107. For example, the battery pack 112 may interface with a charging station, or with other lighting apparatuses. In FIG. 3A, the battery pack 112 is shown to be electrically connectable with multi-functional base 115, which can operate as both a charging station and as a lighting apparatus. The multi-functional base 115 includes a light emitting region 118 (shown in FIGS. 3B and 3C) and a charging port 122 (shown in FIG. 3D). The multi-functional base 115 may serve as both a charging station for battery pack 112, and as a flashlight that is turned on and off with power switch 116. The multi-functional base includes a base connector 117 (which may be similar to the rod-side connector 113), which is configured to engage with the battery-side connector 114.

FIG. 3B shows the multi-functional base 115 in electrical connection with battery pack 112. As shown in FIG. 3B, the multi-functional base 115 includes a power switch 116 and a light emitting region 118. The light emitting region 118 may include one or more LEDs (which may be different types of LEDs) that are selectively energized by the battery pack 112 via the power switch 116. The light emitting region 118 may be substantially flat, such that the multi-functional base 115 can be placed onto a surface with the light emitting region 118 facing downward toward that surface. The power switch 116 may be any type of switch, such as a button with alternating on and off positions.

In some embodiments, the light emitting region 118 includes two or more types of LEDs. In FIG. 3C, the light emitting region 118 includes an annular light emitting substrate 119 that surrounds a reflector 121 that has mounted thereon a base LED 120. The annular light emitting substrate 119 may be any kind of solid-state light emitting material, such as a phosphate. In some implementations, the annular light emitting substrate 119 is a chip-on-board LED, which may comprise two or more separate diodes covered by a phosphorous material.

The base LED 120 may, in some instances, be a surface mounted device (SMD) LED. The base LED 120 may be a “high powered” LED or array of LEDs that emits light out of the light emitting region 118. Light emitted from the base LED 120 may be focused and/or directed by the reflector 121.

In some implementations, power button 116 may, when pressed, cause the light emitting region 118 to operate in different modes. One mode may involve energizing only annular light emitting substrate 119. Another mode may involve energizing only base LED 120. Yet another mode may involve energizing both annular light emitting substrate 119 and base LED 120. An additional mode may involve turning off all LEDs within the light emitting region 118.

The multi-functional base 115 may include additional circuitry or components thereon that facilitates the operation of light emitting region 118 and/or the charging of the battery pack 112. For example, the charging rate of the battery pack 112 may be controlled by a controller embedded between the charging port 122 and the battery pack 112. As another example, some LEDs may require a voltage that differs from the voltage supplied by the battery pack 112 (e.g., higher voltage COB LEDs or an array of LEDs arranged in series), and the multi-functional base 115 might include circuitry to step-up (boost) or step-down (buck) the battery voltage to be compatible with the annular light emitting substrate 119 and/or the base LED 120. Other circuitry is also possible.

FIG. 3D illustrates the multi-functional base 115 having thereon a charging port 122. In this example, the charging port is covered by a protective element, such as a rubber or silicone flange. The charging port 122 may operably receive a corresponding plug from a power source, such as a DC power supply. In some instances, the multi-functional base 115 includes an AC-to-DC converter, and the charging port 122 is configured to receive AC power that is converted by the AC-to-DC converter. Other arrangements are also possible.

Components of detachable lighting apparatus 107 may be secured so as to prevent water or dust from entering into the enclosed LEDs 106 or battery pack under some environmental conditions. For example, the detachable lighting apparatus 107 can be constructed to meet international Protection water and dust resistance codes, such as IP54.

It should be understood that multi-functional lighting apparatuses and removable lighting apparatuses of the present disclosure may include additional elements or components not explicitly shown or described herein. For example, LED devices often include circuitry for driving the LEDs, powering the LEDs, dissipating heat produced by the LEDs or resistive elements electrically coupled to the LEDs, switches or other devices for turning the LEDs on and off, circuit elements for dimming or adjusting the brightness of the LEDs, and/or any other circuit or control element.

Although certain example methods and apparatus have been described herein, the scope of coverage of this disclosure is not limited thereto. On the contrary, this disclosure covers all methods, apparatus, and articles of manufacture fairly falling within the scope of the appended claims either literally or under the doctrine of equivalents.

It should be understood that arrangements described herein are for purposes of example only. As such, those skilled in the art will appreciate that other arrangements and other elements (e.g. machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. It is also to be understood that the terminology used herein is for the purpose of describing particular implementations only, and is not intended to be limiting.

What is claimed is:

1. A portable lighting apparatus comprising:
an elongated housing having a radially-central cavity extending longitudinally along the elongated housing;
one or more rods operable to extend coaxially from the radially-central cavity;
one or more hooks coupled to distal ends of the respective one or more rods;
one or more clips secured to the elongated housing; and
a detachable lighting apparatus removably secured to the one or more clips, the detachable lighting apparatus being substantially cylindrical in shape, wherein the detachable lighting apparatus includes one or more light emitting diodes (LEDs) affixed to a surface of the detachable lighting apparatus and operable to emit light.

2. The portable lighting apparatus of claim 1, wherein the detachable lighting apparatus further comprises:
a substantially cylindrical separable battery operable to supply power to the LEDs of the detachable lighting apparatus.

3. The portable lighting apparatus of claim 2, wherein the detachable lighting apparatus has a first diameter, the substantially cylindrical separable battery has a second diameter, and wherein the first diameter is approximately equal to the second diameter.

4. The portable lighting apparatus of claim 2, wherein the detachable lighting apparatus has a first diameter, the momentary magnetic switch has a second diameter, and wherein the first diameter is approximately equal to the second diameter.

5. The portable lighting apparatus of claim 2, wherein the substantially cylindrical battery is disposed within a battery housing, wherein the one or more LEDs are affixed to a surface of a main housing of the detachable lighting apparatus, and wherein the battery housing is removably coupled to the main housing.

6. The portable lighting apparatus of claim 5, wherein the battery housing includes one or more first electrical contacts, wherein the main housing includes one or more second electrical contacts, and wherein the one or more first electrical contacts electrically couple with the one or more second electrical contacts to provide power to the one or more LEDs.

7. The portable lighting apparatus of claim 1, wherein the detachable lighting apparatus further comprises:
a substantially cylindrical momentary magnetic switch configured to selectively energize the one or more LEDs of the detachable lighting apparatus.

8. The portable lighting apparatus of claim 1, wherein the detachable lighting apparatus comprises a transparent cover at least partially surrounding the one or more LEDs.

9. The portable lighting apparatus of claim 1, wherein the surface of the detachable lighting apparatus on which the one or more LEDs is affixed comprises:
a photoluminescent coating covering at least a portion of the surface of the detachable lighting apparatus, wherein the photoluminscent coating is adapted to emit light for a duration of time after being irradiated by a light source; or
a reflective coating covering at least a portion of the surface of the detachable lighting apparatus, wherein the reflective coating is adapted to distribute light emitted by the one or more LEDs.

10. The portable lighting apparatus of claim 1, wherein at least the one or more LEDs of the detachable lighting apparatus are sealedly contained within a water-resistant housing.

10. The portable lighting apparatus of claim 1, wherein each of the one or more hooks is substantially triangular in shape.

12. The portable lighting apparatus of claim 1, wherein each of the one or more hooks is rotatably coupled to the respective one or more rods.

11. The portable lighting apparatus of claim 1, wherein each of the one or more hooks is detachably coupled to the respective one or more rods.

14. The portable lighting apparatus of claim 1, wherein the one or more LEDs are surface mount device (SMD) LEDs or chips-on-board (COB) LEDs.

15. The portable lighting apparatus of claim 1, wherein the detachable lighting apparatus is at least partially formed from metal and adapted to dissipate heat produced by the one or more LEDs.

16. A detachable lighting apparatus adapted to be removably coupleable with one or more clips secured to an elongated housing, wherein the detachable lighting apparatus is substantially cylindrical in shape, wherein the detachable lighting apparatus comprises:
one or more light emitting diodes (LEDs) affixed to a surface of the detachable lighting apparatus and operable to emit light;
a substantially cylindrical separable battery operable to supply power to the LEDs of the detachable lighting apparatus; and
a substantially cylindrical momentary magnetic switch configured to selectively energize the one or more LEDs with power supplied from the battery.

17. A portable lighting system comprising:
a substantially cylindrical battery pack having a battery and a battery connector that provides an electrical connection to the battery;
a substantially cylindrical portable lighting rod, wherein the portable lighting rod comprises:
one or more light emitting diodes (LEDs) affixed to a surface of the portable lighting rod and operable to emit light;
a power terminal configured to be electrically coupleable with the battery connector; and
a substantially cylindrical momentary magnetic switch configured to selectively energize the one or more LEDs with power supplied from the battery; and
a multi-functional base, the base comprising:
a power terminal configured to be electrically coupleable with the battery connector;
a charging port configured to be electrically coupleable with a power supply, wherein the charging port serves to charge the battery with power provided from the power supply; and
a light emitting region operable to emit light, wherein the light emitting region is selectively energized with power provided by the battery.

18. The portable lighting system of claim 17, wherein the light emitting region comprises:
a light reflector having a substantially paraboloid shape;
one or more base LEDs disposed within the light reflector and operable to emit light; and
an annular light emitting substrate arranged to surround the light reflector, wherein the annular light emitting substrate is operable to emit light.

19. The portable lighting system of claim 17, wherein the annular light emitting substrate is a chip-on-board (COB) LED.

20. The portable lighting system of claim 17, wherein the multi-functional base further comprises:
a power switch configured to selectively energize the light emitting region with power provided by the battery.
